(19) United States
(12) Patent Application Publication
(10) Pub. No.: US 2006/0067680 A1
(43) Pub. Date: Mar. 30, 2006

(54) Portable image capturing device

(75) Inventor: Richard Yang, Hsinchu (TW)

Correspondence Address: BIRCH STEWART KOLASCH & BIRCH, PO BOX 747, FALLS CHURCH, VA, 22040-0747, US

(73) Assignee: Microtek International Inc.

(21) Appl. No.: 11/230,470

(22) Filed: Sep. 21, 2005

(30) Foreign Application Priority Data
Sep. 30, 2004 (TW) 093129660

(51) Int. Cl. G03B 17/02

(52) U.S. Cl. 396/535

(57) ABSTRACT

A portable image capturing device includes a mainframe, an image-sensing module and a lengthening/shortening connection member. The mainframe having an image-processing control unit is received in a mainframe casing for implementing image processing. The image-sensing module having a lens set and a planar image capturing unit is received in an image-sensing module casing for acquiring images. The lengthening/shortening connection member is connected between the mainframe casing and the image-sensing module casing for adjusting the relative position between the mainframe and the image-sensing module.

### BACKGROUND OF THE INVENTION

(a) Field of the Invention

The invention relates to an image capturing device, particularly a portable image capturing device having multiple functions.

(b) Description of the Related Art

FIG. 1A and FIG. 1B respectively show a front view and a rear view of a conventional digital camera 10. FIG. 2 shows a block diagram illustrating the operations of the digital camera. Referring to these figures, the digital camera 10 includes a casing 11. The casing 11 houses an image capturing unit 21, an image-processing control unit 22, a memory 23, a shutter button 12, a liquid crystal display (LCD) 13, a first button 14, a second button 15, and a lens set 16. The image-processing control unit 22 is used to control and execute image processing. The image capturing unit 21 is cooperated with the lens set 16 to acquire images, and a user may push the shutter button 12 to begin image acquisition. The LCD 13 is used to display image and used as an operation interface for a user. The first button 14 is used to trigger the operations of selection and confirmation, and the second button 15 is used to trigger the operations of shrinking or enlarging an image.

The digital camera 10 forms the image of an object on an area charge coupled device (not shown) by means of the image capturing unit 21 and the lens set 16. The image-processing control unit 22 transforms the signals output by the image capturing unit 21 into digital image data, and then the digital image data are stored in the memory 23 and shown on the LCD 13. The digital image data may be transmitted to a personal computer 24 via an interface. Further, batteries are often used as a power source for a typical digital camera 10 to have it become a portable device convenient for outdoor use.

FIG. 3 shows a schematic diagram illustrating a conventional real-object projector 30. FIG. 4 shows a block diagram illustrating the operations of the projector 30. Referring to these figures, the projector 30 includes a first casing 31, a second casing 32, and a connection part 33. The first casing 31 houses an image-processing control unit 42, and the second casing houses an image capturing unit 41. The real-object projector 30 captures the images of a dynamic object or a static figure by means of the image capturing unit 41, where the image are formed on an area charge coupled device (not shown) via a lens set (not shown). The image-processing control unit 42 transforms the signals output by the image capturing unit 41 into digital image data, and then the digital image data are transformed into video signals. The video signals that serve as a real-time image projected on a screen 37 are transmitted to a projector 36 via a video-out interface (such as DVI, analog RGB interface, and composite signal interface). Further, the images stored in a personal computer 24 are transmitted to a real-object projector 30 via a video-in interface and further to the projector 36 via the video-out interface to achieve real-object projection. The real-object projector 30 is designed as a non-portable device since it is often used in office or a conference room capable of providing indoors power source.

FIG. 5 shows a schematic diagram illustrating a conventional business card scanner, and FIG. 6 shows a block diagram illustrating the operations of the business card scanner. Referring to these figures, the scanner 50 includes a casing 51. The casing 51 houses a linear image sensor 52, a chassis 53, a motor drive unit 54, an image-processing control unit 62, and an auxiliary memory 63. When the business card is placed on the business card scanner 50, the motor drive unit 54 is activated to drive the chassis 53 so that the business card is moved and scanned by the linear image sensor 52. Then, the image-processing control unit 62 transforms the scanned image into digital data, and the digital data are stored in the auxiliary memory 63 and then transmitted into a personal computer 24 via an interface. However, the scanning speed of the scanner 50 is low since the card scanning must be performed by a delivery mechanism including the chassis 53, resulting in a waste of time for a user.

As described above, the digital camera, the real-object projector, and the business card scanner have their respective functions and applied fields. Hence, a user must separately purchase all the three devices when these functions are all needed, resulting in a high cost and an inconvenient use. As a result, it is desired to design a portable image capturing device that integrates the functions of the digital camera, the real-object projector, and the business card scanner.

### BRIEF SUMMARY OF THE INVENTION

Hence, an object of the invention is to provide a portable image capturing device that integrates the functions of a digital camera, a real-object projector, and a business card scanner to result in a reduced cost, convenient use and fast scan.

According to the invention, a portable image capturing device having multiple functions includes a mainframe, an image-sensing module and a lengthening/shortening connection member. The mainframe having an image-processing control unit is received in a mainframe casing for controlling and executing image processing. The image-sensing module having a lens set and a planar image capturing unit is received in an image-sensing module casing for acquiring images. The lengthening/shortening connection member is connected between the mainframe casing and the image-sensing module casing for adjusting the relative position between the mainframe and the image-sensing module.

Through the design of the invention, the lengthening/shortening connection member allows for adjusting the relative position between the mainframe, the mainframe additionally includes an auto sheet-feeding unit, and the planar image capturing unit performs a wide-area scan. All these features make the portable image capturing device, capable of serving as a digital camera, a real-object projector, or a business card scanner, have a reduced cost, convenient use and fast scan.

### BRIEF DESCRIPTION OF THE DRAWINGS

FIG. 1A and FIG. 1B respectively show a front view and a rear view of a conventional digital camera.

FIG. 2 shows a block diagram illustrating the operations of the digital camera.

FIG. 3 shows a schematic diagram illustrating a conventional real-object projector.

FIG. 4 shows a block diagram illustrating the operations of the projector.

FIG. 5 shows a schematic diagram illustrating a conventional business card scanner.

FIG. 6 shows a block diagram illustrating the operations of the business card scanner.

FIG. 7A and FIG. 7B respectively show a front view and a rear view of a portable image capturing device according to the invention.

FIG. 8 shows a block diagram illustrating the operations of the portable image capturing device.

FIG. 9A is a schematic diagram illustrating an embodiment of the invention, where the lengthening/shortening connection member is lengthening.

FIG. 9B is a schematic diagram showing the relative position between a mainframe and an image-sensing module.

FIG. 10A is a schematic diagram illustrating an embodiment of the invention, where the portable image capturing device functions as a digital camera.

FIG. 10B is a schematic diagram illustrating an embodiment of the invention, where the portable image capturing device functions as a real-object projector.

FIG. 10C is a schematic diagram illustrating an embodiment of the invention, where the portable image capturing device functions as a business card scanner.

### DETAILED DESCRIPTION OF THE INVENTION

The portable image capturing device according to the invention will be described with reference to the accompanying drawings.

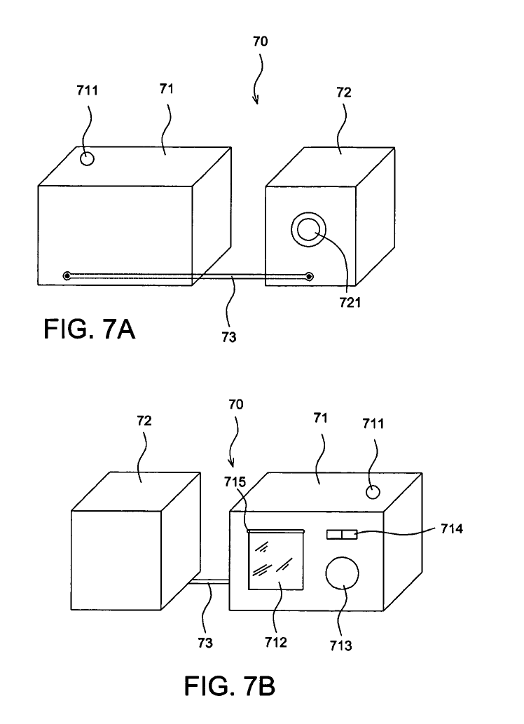

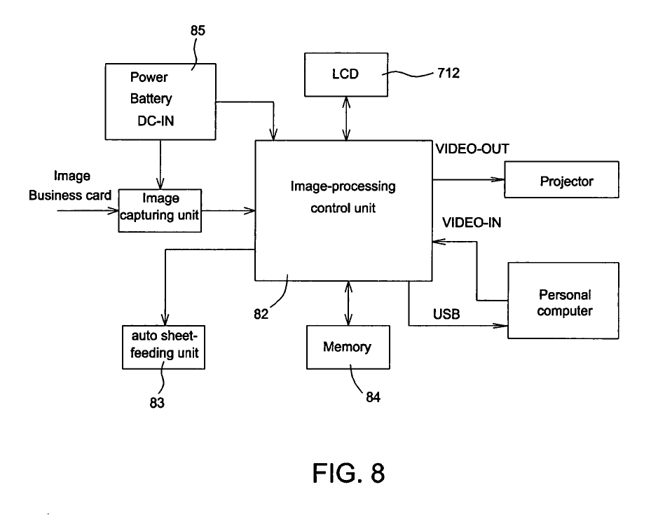

FIG. 7A and FIG. 7B respectively show a front view and a rear view of a portable image capturing device 70 according to the invention. FIG. 8 shows a block diagram illustrating the operations of the portable image capturing device 70. Referring to FIG. 8, the image capturing device 70 includes a mainframe 71, an image-sensing module 72, and a lengthening/shortening connection member 73, where the mainframe 71 and the image-sensing module 72 are received in distinct casings.

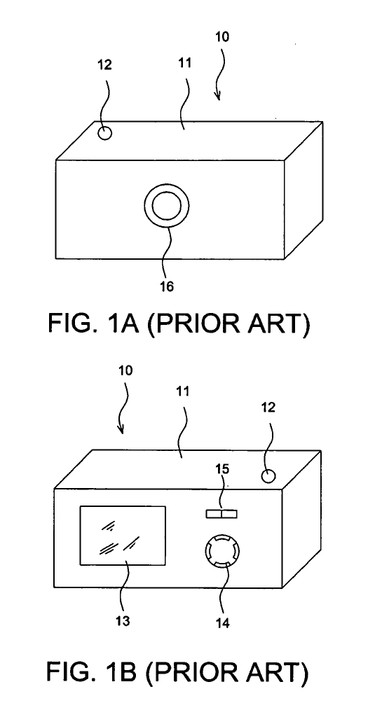

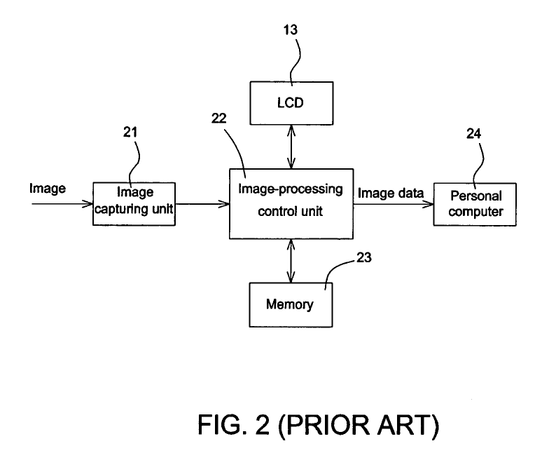

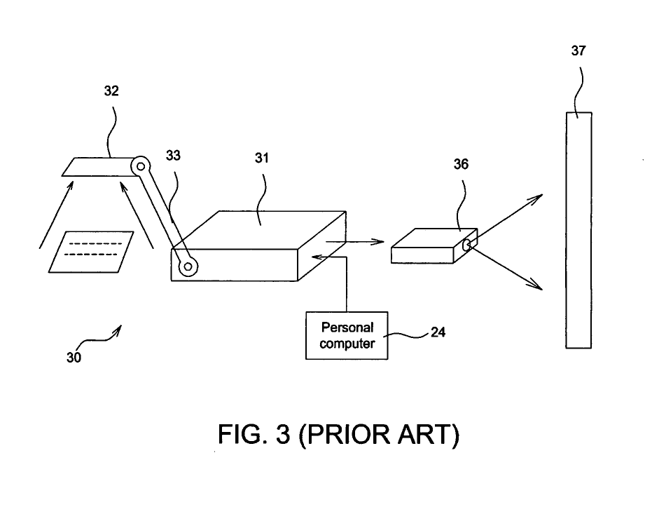

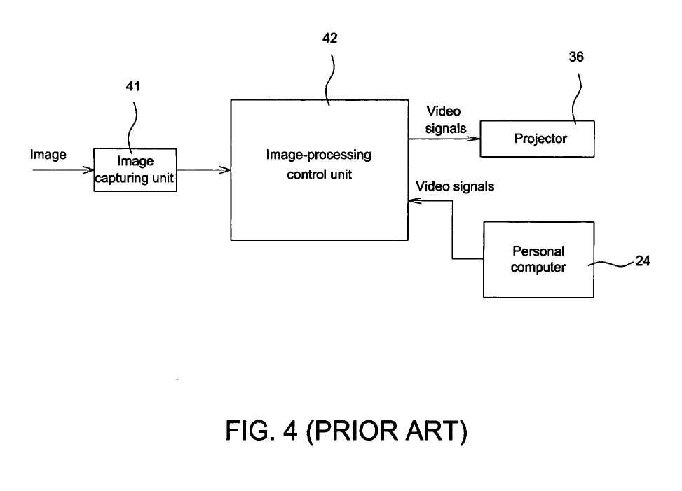

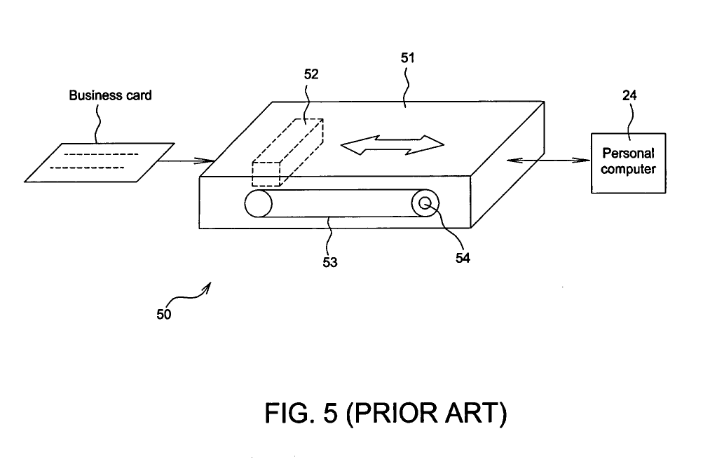

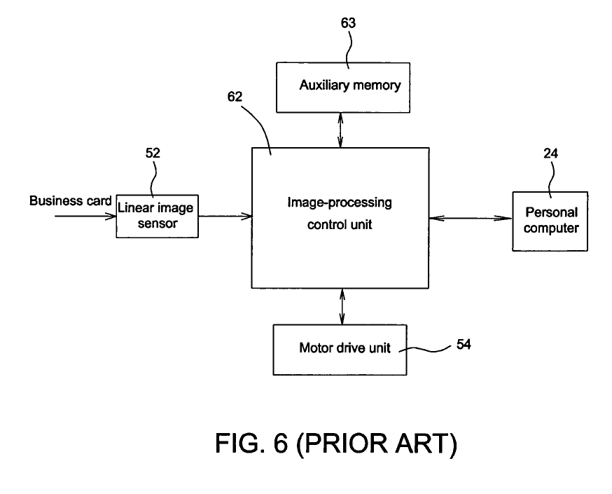

The mainframe 71 includes an image-processing control unit 82, an auto sheet-feeding unit 83, a memory 84, a shutter button 711, a liquid crystal display (LCD) 712, a first button 713, a second button 714, and an angle-adjusting unit 715. The construction of the image-processing control unit 22 is similar to a conventional digital camera (shown in FIGS. 1A and 1B), except that the former additionally includes the auto sheet-feeding unit 83 and the angle-adjusting unit 715, and that a planar image capturing unit 722 is further provided in the image-sensing module 72. The auto sheet-feeding unit 83 is used to feed a sheet into or deliver it from the mainframe 71. The angle-adjusting unit 715 is connected with the LCD 712 to adjust the angle made by the mainframe 71 and the LCD 712.

The image-sensing module 72 includes a lens set 721 and a planar image capturing unit 722, where the planar image capturing unit 722 is provided with an area charge coupled device (not shown). The lens set 721 is cooperated with the planar image capturing unit 722 to acquire images.

The two free ends of the lengthening/shortening connection member 73 are connected to the mainframe 71 and the image-sensing module 72, respectively, so that the relative position of the mainframe 71 and image-sensing module 72 is adjustable. The lengthening/shortening connection member 73 may accommodate signal lines inside to achieve signal communication between the mainframe 71 and the image-sensing module 72.

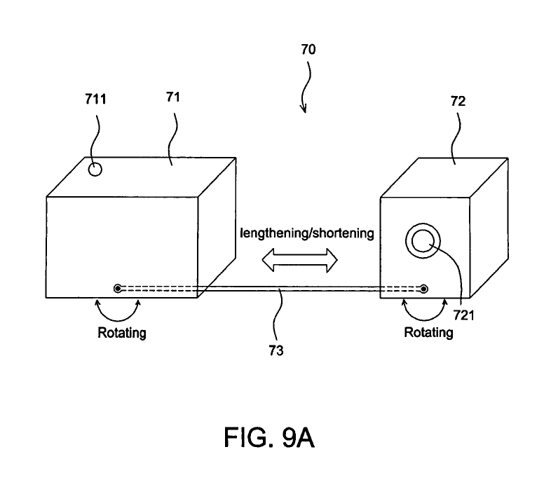

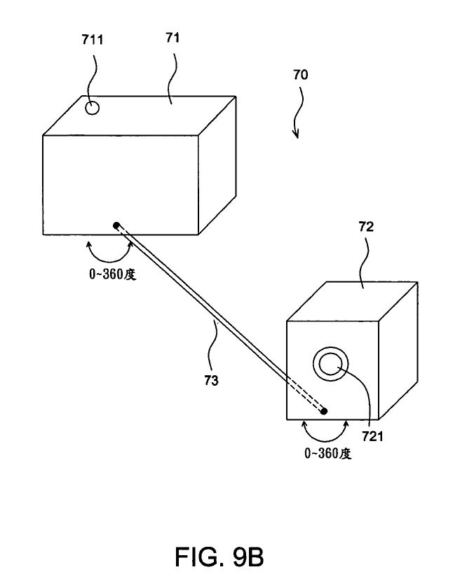

The lengthening/shortening connection member 73 is totally different to a connection part 33 of a conventional real-object projector 30. According to the invention, the connection member 73 is a connection rod capable of lengthening and shortening. Besides, referring to FIG. 9A, the mainframe 71 and the image-sensing module 72 are pivotally connected on two ends of the connection rod to allow each of them to have a 360 degrees rotation relative to one end of the connection rod, as shown in FIG. 9B.

Note that the image capturing device according to the invention is portable when batteries or a DC-IN adapter is used, as illustrated in block 85 of FIG. 8.

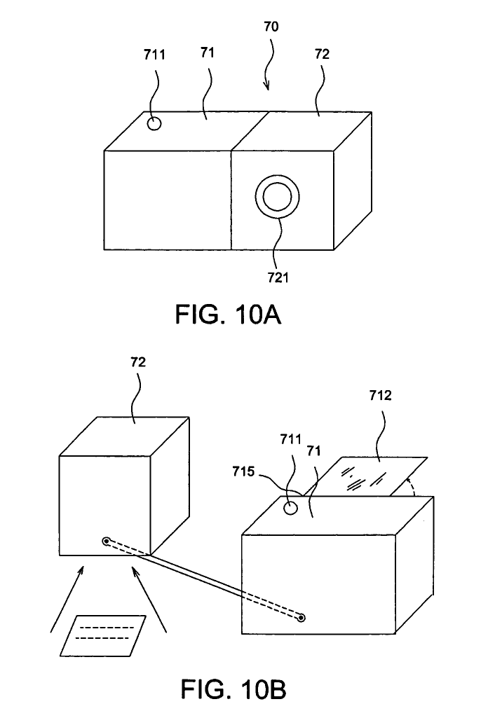

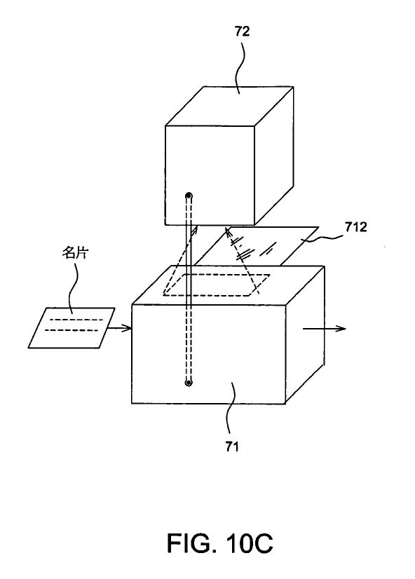

Referring to both FIG. 10A and FIG. 8, when a user push the shutter button 711, the planar image capturing unit 722 images an object on the area charge coupled device through the lens set 721. Then, the image-processing control unit 82 transforms the image into digital data, and the digital image data are stored in the memory 84 and displayed on the LCD 712. Thereby, the portable image capturing device functions as a digital camera.

Referring to both FIG. 10B and FIG. 8, on the other hand, the portable image capturing device 70 also functions as a real-object projector. In that case, the planar image capturing unit 722 of the image-sensing module 72 serves to scan a document and form an image on the area charge coupled device. The image-processing control unit 82 transforms the image into digital data, and, like a conventional real-object projector, the digital image data are transformed into video signals and then transmitted to a projector 36 via a video-out interface to perform a real-time object projection. Besides, the image stored in a personal computer 24 may be transmitted to the real-object projector via a video-in interface and further to the projector 36.

Referring to both FIG. 10C and FIG. 8, the portable image capturing device 70 further functions as a business card scanner. When a business card is put in the auto sheet-feeding unit 83, the auto sheet-feeding unit 83 feeds the business card into the mainframe 71, and then the planar image capturing unit 722 scans the business card to form an image on the area charge coupled device. The image-processing control unit 82 transforms the image into digital data, and then the auto sheet-feeding unit 83 delivers the business card out of the image capturing device 70. Note that a user may directly put the business card on the mainframe 71 to perform the scan, so that the auto sheet-feeding unit 83 may be omitted.

Besides, in all embodiments described above, the angle-adjusting unit 715 is capable of arbitrarily adjusting the LCD 712 to a proper position so that a user is easy to operate the image capturing device. Also, according to the invention, the images can be directly transmitted to the projector 36 for a real-time projection, and the use of batteries may eliminate the need of an indoor power source. Hence, the portable image capturing device 70 according to the invention may function as either a digital camera, a real-object projector, or a business card scanner. As the portable image capturing device 70 functions as a business card scanner, the planar image capturing unit 722 that performs a wide-area scan may replace a conventional linear image sensor 52 driven by a delivery mechanism, so that the scanning speed is improved.

According to the design of the invention, the lengthening/shortening connection member 73 allows for adjusting the relative position between the mainframe 71, the mainframe 71 additionally includes an auto sheet-feeding unit 83, and the planar image capturing unit 722 performs a wide-area scan. All these features make the portable image capturing device 70, capable of serving as either a digital camera, a real-object projector, or a business card scanner, have a reduced cost, convenient use and fast scan. Further, since the lengthening/shortening connection member 73 is capable of lengthening and shortening, and the mainframe 71 and the image-sensing module 72 are pivotally connected on two ends of the connection member 73 to allow each of them to have a 360 degrees rotation relative to the connection member 73, an optimized angle for image acquisition is easy to be obtained to result in a fine scan.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A portable image capturing device, comprising:
a mainframe having an image-processing control unit and received in a mainframe casing for controlling and executing image processing;
an image-sensing module having a lens set and a planar image capturing unit and received in an image-sensing module casing for capturing images;
a lengthening/shortening connection member connected between the mainframe casing and the image-sensing module casing for adjusting the relative position between the mainframe and the image-sensing module.

2. The portable image capturing device as claimed in claim 1, wherein the mainframe further comprises:
a shutter button used to trigger image acquisition;
a liquid crystal display used to display image and used as an operation interface for an user;
a first button used to trigger the operations of selection and confirmation; and
a second button used to trigger the operations of shrinking or enlarging the images.

3. The portable image capturing device as claimed in claim 2, wherein the mainframe further comprises an angle-adjusting unit connected with the liquid crystal display for adjusting the angle made by the mainframe and the liquid crystal display.

4. The portable image capturing device as claimed in claim 1, wherein the mainframe further comprises an auto sheet-feeding unit used to feed a sheet into the mainframe or to deliver the sheet out of the mainframe.

5. The portable image capturing device as claimed in claim 1, wherein the mainframe and the image-sensing module are pivotally connected on two ends of the lengthening/shortening connection member to allow each of them to have a 360 degrees rotation relative to the lengthening/shortening connection member.
